(19) United States
(12) Patent Application Publication
(10) Pub. No.: US 2008/0285821 A1
(43) Pub. Date: Nov. 20, 2008

(54) Method, a System and a Computer Program for Image Segmentation

(75) Inventors: Christian Adrian Cocosco, Hamburg (DE); Thomas Netsch, Eindhoven (NL); Daniel Bystrov, Hamburg (DE); Stewart Young, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,842

(22) PCT Filed: Sep. 7, 2006
(86) PCT No.: PCT/IB2006/053141

§ 371 Date: Aug. 6, 2008

(30) Foreign Application Priority Data
Sep. 23, 2005 (EP) 05108790.6

(51) Int. Cl. G06K 9/00

(52) U.S. Cl. 382/128

(57) ABSTRACT

The invention relates to a method 1 of image segmentation where in step 2 a prior model representative of a structure conceived to be segmented in an image is accessed. Preferably, the image comprises a medical diagnostic image. Still preferably, the medical diagnostic image is prepared in a DICOM format, whereby supplementary information is stored besides diagnostic data. In these cases the method 1 according to the invention advantageously proceeds to step 3, where the supplementary information is extracted from electronic file 5, comprising for example suitable patient-related information 5a and/or suitable structure-related information 5b. Examples of the patient-related information comprise a patient's age, sex, group, etc., whereas examples of the structure-related information may comprise an anatomic location of the structure, such as rectum, bladder, lung etc, or the suspected/diagnosed pathology of the patient. In an alternative embodiment of the method 1 according to the invention, the supplementary information is provided by a human operator in step 7, where he can enter suitable supplementary information 9a, 9b using a user interface 9. When the supplementary information is loaded, the method 1 according to the invention proceeds to step 4 in which the prior model is being changed using the supplementary information yielding a further model. In step 6 the method 1 performs the image segmentation using the thus obtained further model and in step 8 the results of the segmentation step may be visualized on a suitable viewer.

The invention relates to a method of image segmentation comprising the step of accessing a prior model representative of a structure conceived to be segmented in an image.

The invention further relates to a system for image segmentation comprising an input for accessing a prior model representative of a structure conceived to be segmented in an image.

The invention still further relates to a computer program for enabling an image segmentation, said computer program comprising instructions causing a processor to carry out the step of accessing a prior model representative of a structure conceived to be segmented in an image.

An embodiment of the method as set forth in the opening paragraph is known from WO 2005/008587 A1. The known method is arranged to segment an image, notably a medical diagnostic image, using a model-based segmentation method, whereby organ models are represented by flexible surfaces and are adapted to boundaries of the object of interest. For this purpose the known method is further arranged to use organ-specific data, such as shape properties of an organ or organ boundary characteristics, such as a gradient, a gradient direction and an intensity range, or tissue properties of the organ. The shape model is then used in its unaltered form and is being deformed by a suitable image segmentation algorithm whereby organ-specific data are used to adapt said model to object boundaries.

It is a disadvantage of the known method that it uses an a-priori constructed prior model, notably a shape model, which is built based on a number of example images and corresponding results of their respective image segmentations. For medical applications, since these example segmentations are difficult to collect, they typically represent the normal subject population images. Moreover, the a-priori constructed shape model cannot comprise a variety of shapes and sizes of the human population and cannot represent most pathologies. Both shortcomings lead to inferior segmentation results, in particular, for atypical images.

It is an object of the invention to provide a method for image segmentation which is robust for a substantially wide range of subjects. To this end the method according to the invention comprises the following steps:
accessing supplementary information;
changing the prior model using the supplementary information yielding a further model.

The technical measure of the invention is based on the insight that by providing the supplementary information the prior model can easily be changed meeting the requirements of a current case. It is noted that the prior model may comprise a shape model, an organ size model, representing physical dimensions of an organ, a motion model, an image contrast and/or appearance model, etc. In terms of the invention, it is understood that the term ‘changing’ refers either to amending/adjusting the accessed prior model or to diverting to a different prior model. The latter possibility is advantageous when segmenting medical data showing an abnormality, like pathology in anatomical data.

In an embodiment of the method according to the invention the supplementary information is retrieved from the image data.

Preferably, for medical images stored in a DICOM (Digital Communication in Medicine) format, supplementary information, such as the age of a patient, gender, body size, etc. can be automatically retrieved in an electronic form. The invention is not limited to operating with DICOM images, other possibilities of digital data extraction comprise Picture Arching and Communication (PACS), Hospital Information Systems (HIS) and/or Radiology Information Systems (RIS) sources, or any other electronic formats enabling access to supplementary information next to image data. The technical measure of the invention ensures an increased level of automation during data processing. Alternatively, the supplementary information can be provided by a human operator in an interactive way, for example using a suitable user interface. This supplementary information is used to adapt the expected size and/or expected shape of an anatomical structure conceived to be segmented, for example by scaling the overall size of the prior model. Alternatively, a different prior model from a pre-stored set of available models can be selected in lieu of the accessed prior model, for example a suitable model representing a pathology expected or diagnosed in a patient. Still alternatively, the prior model can be substituted by another model representative of a population group the patient belongs to.

In a further embodiment of the method according to the invention, the method further comprises the step of performing an image segmentation using the further model.

According to this technical measure a robust image segmentation method is enabled, which provides reliable segmentation results for a great variety of population groups, is age-specific and is capable of coping with atypical shapes representative of pathologies.

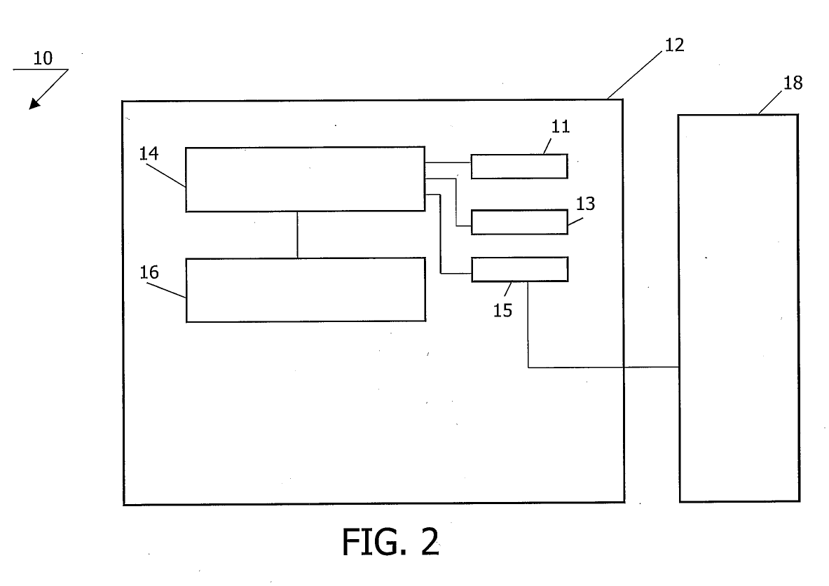

In the system according to the invention the input is further arranged for accessing supplementary information, the system further comprising a processor unit for changing the prior model using the supplementary information yielding a further model. Further advantageous embodiments of the system according to the invention are given in claims 7 and 8. The system according to the invention will be described in more detail with reference to FIG. 2.

The computer program according to the invention for enabling image segmentation comprises further instructions causing a processor to carry out the following steps:
accessing supplementary information;
changing the prior model using the supplementary information yielding a further model.

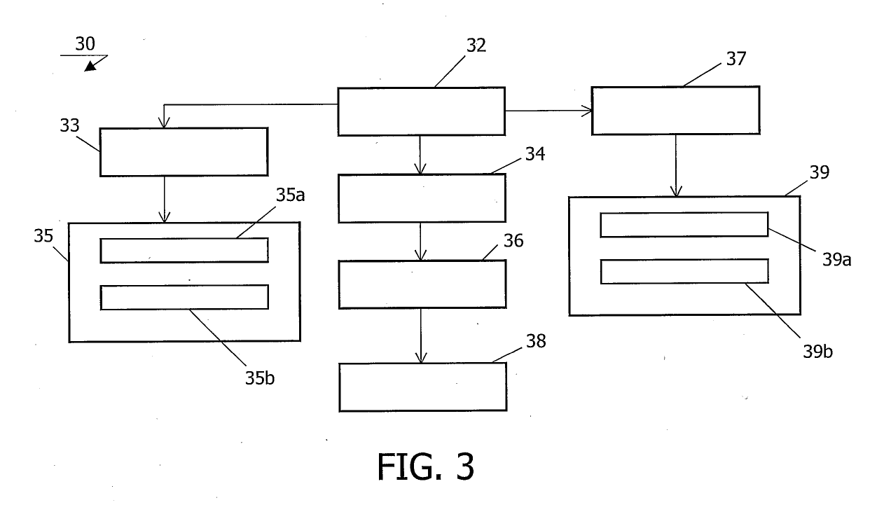

Further advantageous embodiments of the computer program according to the invention are given in claims 10 and 11. The computer program according to the invention provides means for enabling automatic robust image segmentation, whereby accurate results are obtainable for a great variety of structures, and, more specifically, for a great variety of patient groups and health conditions. Further advantages of the computer program according to the invention will be discussed with reference to FIG. 3.

These and other aspects of the invention will be discussed with reference to the following figures.

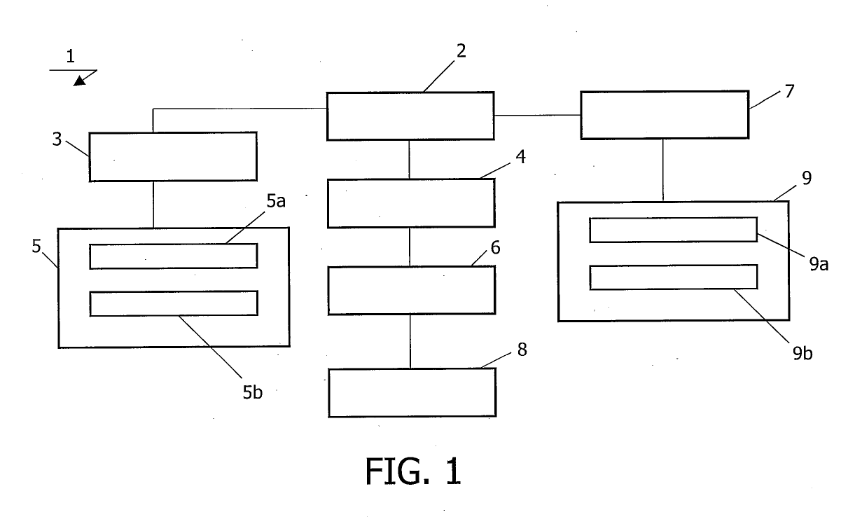

FIG. 1 presents a schematic view of an embodiment of a method according to the invention.

FIG. 2 presents a schematic view of an embodiment of a system according to the invention.

FIG. 3 presents a schematic view of a flow-chart of a computer program according to the invention.

FIG. 1 presents a schematic view of an embodiment of a method according to the invention. In step 2 of the method 1 of the invention a prior model representative of a structure conceived to be segmented in an image is accessed. Preferably, the image comprises a medical diagnostic image. Still preferably, the medical diagnostic image is prepared in a DICOM format, whereby supplementary information is stored besides diagnostic data. Alternatively, the diagnostic image may be stored in any other electronic format comprising supplementary information, for example originating from a PACS/HIS/RIS source. In these cases the method 1 according to the invention advantageously proceeds to step 3, whereby the supplementary information is extracted from electronic file 5, comprising, for example suitable patient-related information 5a, and/or suitable structure-related information 5b. Examples of the patient-related information comprise the patient's age, sex, group, etc., whereas an example of the structure-related information may comprise an anatomic location of the structure, such as rectum, bladder, lung etc, or the suspected/diagnosed pathology of the patient. In an alternative embodiment of the method 1 according to the invention, the supplementary information is provided by a human operator in step 7, where he can enter suitable supplementary information 9a, 9b using a user interface 9. When the supplementary information is loaded, the method 1 according to the invention proceeds to step 4 in which the prior model is changed using the supplementary information yielding a further model. The process of changing in the context of the invention must be understood either as updating the initial prior model, like resizing, or, alternatively, deviating to a different prior model, like selecting a prior model representative of a certain patient group, or abnormality detected (or suspected from prior clinical examination) in the structure conceived to be segmented. In step 6 the method 1 performs the image segmentation using the thus obtained further model and in step 8 the results of the segmentation step may be visualized on a suitable viewer.

FIG. 2 presents a schematic view of an embodiment of a system according to the invention. The system 10 according to the invention for image segmentation comprises a computer 12 with an input 14 for accessing a prior model 11 representative of a structure conceived to be segmented in an image 15. The input 14 is further arranged to access the supplementary information 13, whereas the processing unit 16 is arranged to change the prior model 11 in accordance with the supplementary information. As has been explained with reference to FIG. 1, the supplementary information 13 can be loaded directly from the image 15, or, alternatively, it can be loaded from a user interface upon an event that a human operator has provided it. Preferably, the system 10 further comprises a suitable apparatus, notably a medical diagnostic apparatus 18 arranged for providing the image 15.

FIG. 3 presents a schematic view of a flow-chart of a computer program according to the invention. An instruction 32 of the computer program 30 of the invention causes a suitable processor (not shown) to access a prior model representative of a structure conceived to be segmented in an image. Preferably, the image comprises a medical diagnostic image. Still preferably, the medical diagnostic image is prepared in a DICOM format, whereby supplementary information is stored besides diagnostic data. Alternatively, the diagnostic image may be stored in any other electronic format comprising supplementary information, for example originating from a PACS/HIS/RIS source. In these cases the computer program 30 according to the invention advantageously comprises an instruction 33, causing the processor to extract the supplementary information from electronic file 35. The supplementary information comprises, for example, suitable patient-related information 35a, and/or suitable structure-related information 35b. Examples of the patient-related information comprise the patient's age, sex, group, etc., whereas an example of the structure-related information may comprise an anatomic location of the structure, such as rectum, bladder, lung etc. In an alternative embodiment of the computer program 30 according to the invention the computer program comprises an instruction 37 causing to receive the supplementary information 39a, 39b using a suitable user interface 39. When the supplementary information is loaded, the computer program 30 according to the invention proceeds to a further step, where by means of an instruction 34 the prior model is changed using the supplementary information yielding a further model. The process of changing in the context of the invention must be understood either as updating the prior model, such as resizing, or deviating to a different model, like selecting a model representative of a certain patient group, or abnormality detected in the structure conceived to be segmented. Using a further instruction 36 the computer program 30 performs the image segmentation using the thus obtained further model. Preferably, the computer program 30 further comprises an instruction 38 causing the processor to visualize results of the segmentation step on a suitable viewer.

1. A method (1) of image segmentation comprising the steps of:
accessing (2) a prior model representative of a structure conceived to be segmented in an image;
accessing (3) supplementary information (5a, 5b);
changing (4) the prior model using the supplementary information (5a, 5b) yielding a further model.

2. A method according to claim 1, wherein the supplementary information (5a, 5b) is retrieved from the image data (5).

3. A method according to claim 1, wherein for an image a medical image is selected, the method further comprising the step of selecting patient-related information (5a) for the supplementary information.

4. A method according to claim 1, wherein for an image a medical image is selected, the method further comprising the step of selecting structure-related information (5b) for the supplementary information.

5. A method according to claim 1, said method further comprising the step of performing an image segmentation (6) using the further model.

6. A system (10) for image segmentation comprising:
an input (14) for
i. accessing a prior model (11) representative of a structure conceived to be segmented in an image (15);
ii. accessing supplementary information (13);
a processor unit (16) for changing the prior model using the supplementary information yielding a further model.

7. A system according to claim 6, wherein the input is further arranged for accessing an image conceived to be segmented, the processor being further arranged for retrieving the supplementary information (13) from the image (15).

8. A system according to claim 6, wherein the processor unit (16) is further arranged to segment the image using the further model.

9. A computer program (30) for enabling an image segmentation, said computer program comprising instructions causing a processor to carry out the following steps:
accessing (32) a prior model representative of a structure conceived to be segmented in an image;
accessing (33) supplementary information (35a, 35b);
changing (34) the prior model using the supplementary information yielding a further model.

10. A computer program according to claim 9, further comprising instructions (33) to access image data and to retrieve the supplementary information from the image data (35).

11. A computer program according to claim 10, further comprising instructions (36) for performing an image segmentation using the further model.
